(19) United States
(12) Patent Application Publication
(10) Pub. No.: US 2012/0067528 A1
(43) Pub. Date: Mar. 22, 2012

(54) LEAD SCREW DRIVEN CHAIN DRIVE MODULAR MANUALLY OPERATED WINDOW SHADE SYSTEM FOR AN AIRCRAFT

(76) Inventor: Nicholas C. Mohat, San Antonio, TX (US)

(21) Appl. No.: 13/233,685

(22) Filed: Sep. 15, 2011

Related U.S. Application Data
(60) Provisional application No. 61/383,489, filed on Sep. 16, 2010.

(51) Int. Cl. B64C 1/14; A47H 5/00

(52) U.S. Cl. 160/84.02; 160/371

(57) ABSTRACT

A modular window unit for an aircraft or other vehicle is disclosed. The modular window unit includes a shade assembly having a shade, a fixed shade rail, and a removable shade rail. The shade rail assembliy engages a frame. An inner and outer lens also engage the frame or elements engaged with the frame. A drive system, either electric or manual, moves the shade between an opened and closed position. The drive system includes a drive sprocket, a metal link chain, and an idler sprocket. Insulation may be provided on one or more elements of the modular window unit to help keep down noise and vibration.

This application claims the benefit of U.S. Provisional Patent Application Ser. No. 61/383,489, filed Sep. 16, 2010. This application incorporates by reference the following U.S. Pat. Nos. 4,679,610; 5,082,043; 4,998,576; 6,832,641; and 6,745,810.

### BACKGROUND OF THE INVENTION

The afore stated patents incorporated by reference disclose window designs for application in an aircraft environment. These types of windows must be lightweight and capable of withstanding some flexing. Most of these designs are modular. The manual designs use a handle, operated by a passenger, typically moving left and right (horizontally) to move a shade vertically up and down. Electtic windows have electric drive motors controlled through a switch by the cabin passenger.

All of the prior art windows use cog or toothed belts for engaging through configured pulleys, sprockets or the like, a drive mechanism, and shade rail of the shade.

### SUMMARY OF THE INVENTION

A modular window for an aircraft, the modular window comprising a reveal, a shade assembly having a fixed shade rail and a movable shade rail, the shade rails engaging a shade, a frame for engaging the fixed shade rail, an inner lens for engaging the frame, an outer lens for engaging the frame, a drive system for engaging the frame and the movable shade rail for moving the shade between an open position and a closed position, the closed position for preventing substantial light from passing through the window, the drive system comprising a drive sprocket, a metal link chain, and an idler sprocket, the drive system including drive means for engaging and rotating the drive sprocket.

Applicant provides a modular window shade unit as known in the prior art, except wherein the lead screw or other manual or electric drive system includes a metal link chain rather than a belt drive for movement of the shade rail between an opened and closed position.

A modular window for an aircraft, the modular window comprising a reveal; a shade assembly having a shade, a fixed shade rail and a movable shade rail, the shade rails engaging the shade; a frame for engaging the fixed shade rail; an inner lens for engaging the frame; an outer lens for engaging the reveal; a drive system for engaging the frame and the movable shade rail for moving the shade between an open position and a closed position, the closed position for substantially preventing light from passing through the modular window, the drive system comprising a drive sprocket, a metal link chain, and an idler sprocket, the drive sprocket and idler sprocket engaging the metal link chain, the drive system including drive means for engaging and rotating the drive sprocket; further including insulation, the insulation for location in a non-view obscuring area of the modular window; wherein the shade is a pleated shade; wherein the drive means comprises a handle adapted to be grasped manually and moved with respect to the frame; wherein the drive means comprises an electric motor adapted to engage the frame, the drive sprocket, a remote electrical power source, and an electrical switch, the electric motor configured to rotate the drive sprocket responsive to manual input to the switch; and further including insulation, the insulation for location in a non-view obscuring area of the modular window.

### BRIEF DESCRIPTION OF THE DRAWING

FIG. 1 is a front elevational view of the modular window assembly (manual drive) with the inner lens removed therefrom.

FIG. 2 is a side elevational cutaway through the section designated A-A′.

FIG. 3 is a top elevational view of the modular window assembly.

FIG. 4 is a rear elevational view of the modular window assembly.

### DETAILED DESCRIPTION OF THE PREFERRED EMBODIMENT

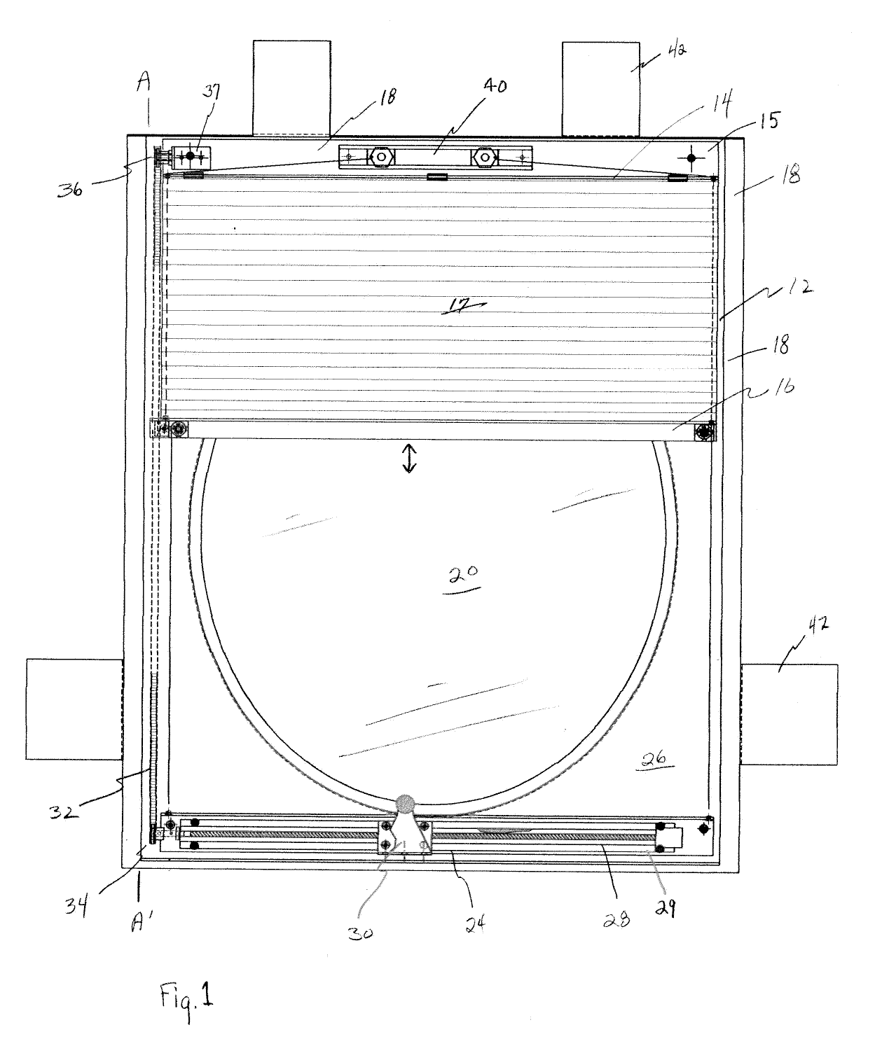

FIGS. 1-4 illustrate a modular window assembly 10, including Applicant's novel metal link chain 32 and toothed drive and idler sprockets 34/36, which are seen to engage a drive system 24 which may be manual or electric (manual illustrated).

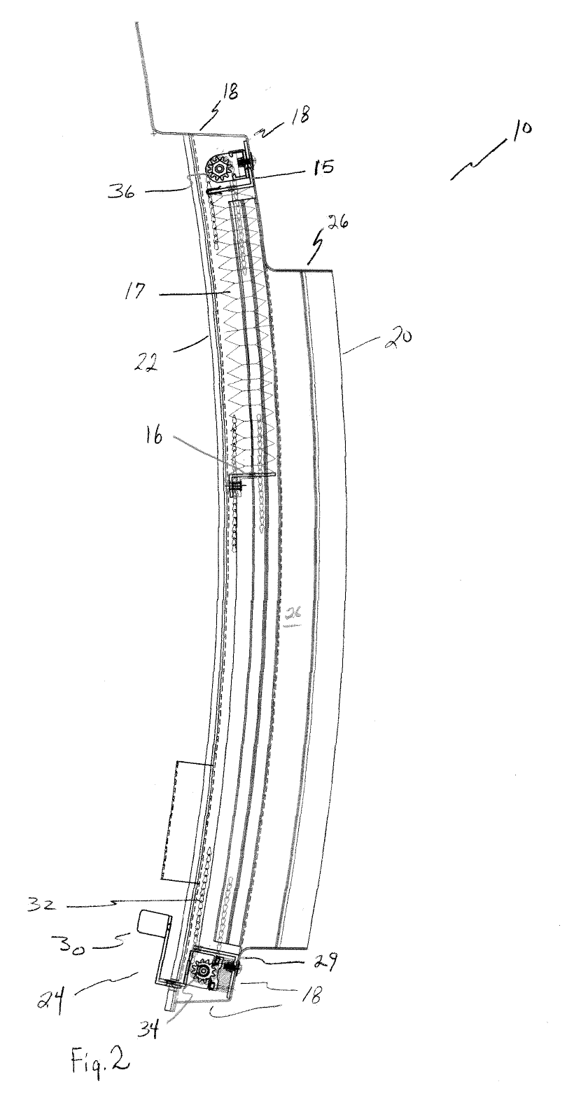

Modular window assembly 10 includes a shade assembly 12. The shade assembly comprises a fixed shade rail 14, a moveable shade rail 16, and a shade 17, such as a pleated shade, attached to the underside of the fixed shade rail and the upper surface of the moveable shade rail. Fixed shade rail 14 is engaged to an upper member of a frame 18 by fixed shade rail mounting bracket 15. Frame 18 comprises a housing or perimeter member along which elements of the fixed shade rail and a drive system 24 may be engaged. Here, frame 18 is seen to be integral with and at the outside perimeter of a molded reveal 26 to which an outer lens 20 is engaged. That is to say, the frame may be molded integral with the reveal and located at the outer border of the reveal. It is typically rectangular as seen, for example, in FIGS. 1 and 2.

Frame 18 and reveals 26 are known in the art, as are modular window assemblies generally. However, modular window assemblies that incorporate drive systems 24, wherein the drive systems include cogs or sprockets and a drie member, have not heretofore provided metal link chains 32 rather than drive belts. A priro art drive belt and cogs may be found in the '641 patent, which is incorporated herein by reference. Links may be about ⅛ inch wide and rotatably coupled to adjacent links.

Outer lens 20 and inner lens 22 substantially enclose the elements of modular window assembly 10. Outer lens 20 may be oval and comprised of substantially transparent Lexan plastic (or other suitable material) and may be sealed to the inner perimeter of reveal 26 as seen, for example, in FIG. 4. Inner lens 22 is similar to outer lens and may be sealed to an inner face of frame in ways known in the art.

Modular window assembly 10 may be curved as best seen in FIG. 2 to conform to the curved inner surface of an aircraft cabin and may include mounting brackets 42 configured to engage elements of the aircraft fuselage and/or cabin. Drive system 24 may be manual or electric. FIGS. 1-4 illustrate a manual drive system. For the purposes of illustration. the '641 patent illustrates the use of an electric drive system. The drive system of the shade functions to move the shade rail between an opened and closed position. The opened position allows light to come through the modular window assembly 10 and the closed position substantially prevents the passage of light therethrough.

Applicant replaces a drive system using sprockets, the toothed belt (see the '641 patent) with a metal chain link 32, which comprises a multiplicity of metal links rotatably coupled to one another, dimensioned to engage teeth on a drive and idler sprocket 34/36, respectively. Here, a drive sprocket 34 is seen to engage a lead screw 38. Lead sore 38 is part of a manual drive system and will couple with a handle 30. Handle 30 may be manually grasped by a passenger seated adjacent the window in the aircraft and moved to the left and right. Handle 30 is slideably engaged to the frame or elements engaged with the frame and lead screw 38 is rotatably mounted to a lead screw mounting bracket 29. Lead screw 38 has drive sprocket 34 at a removed end thereof. Lead screws and handles similar to those shown have been used in the prior art, but not with metal link chains 32 nor with the tooth drive and idler sprockets adapted with teeth dimensioned to eceive the links.

In the application of electric drive systems (not shown), the drive shaft of the electric motor will contain at the removed end thereof, a drive sprocket 34 (similar to that set forth herein for the manual drive) and use idler sprocket 36 along with the metal link chain 32 as illustrated to move the shade rail between an opened and closed position. Alignment mechanism 40 is known in the art (see '610 patent). Alignment mechanism 40 maintains alignment of the moveable shade rail as it moves up and down as seen in FIG. 1, that is, so it does not jam in at a cocked angle.

The metal link chain 32 may be sourced from a number of chain manufacturers, as drive/idler sprockets 34/36.

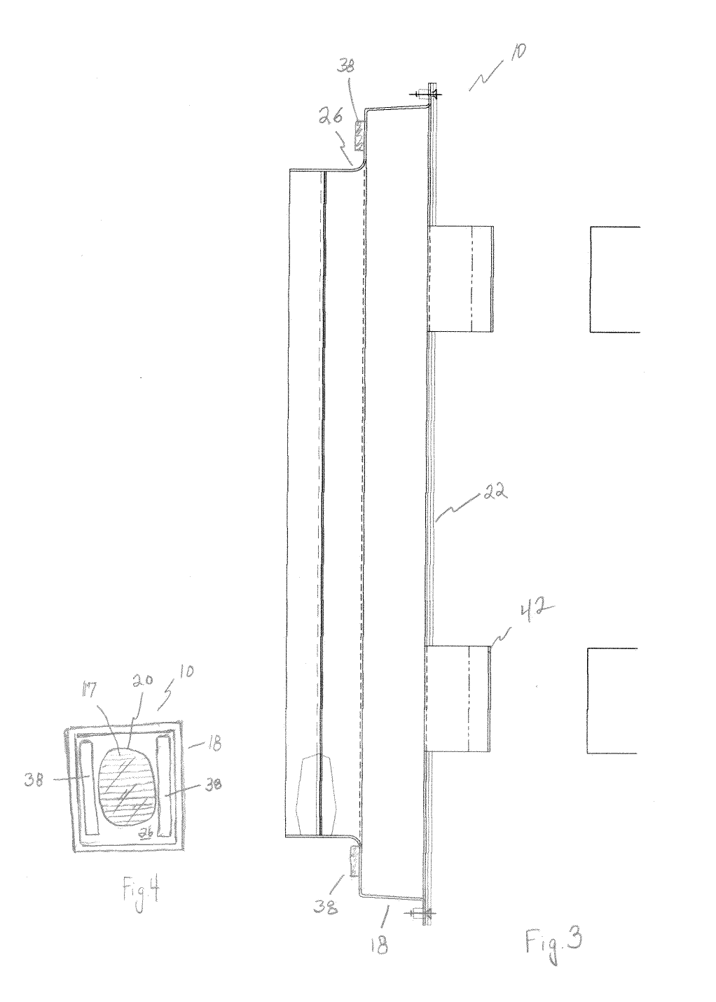

In addition to the use of metal link chain 32. Applicant may use insulation 38 as seen in FIGS. 3 and 4, so as to help quiet the generation of noise by the drive system or the transmission of noise through the window of modular window assembly 10. One location for placement of insulation 38 is the outer surface of the reveal, where it will not be seen by the passengers or anyone when the window is in place in the aircraft. Insulation 38 may be used in any suitable location, but preferably where it is not visible. Insulation 38 may be in any suitable form, but may be foam strips with self-adhesive backing, such as ⅛-⅜ inch thick foam, 12-24 inches long, and ½-3 inches wide strips for placement, as generally seen in FIG. 4.

Although the invention has been described in connection with the preferred embodiment, it is not intended to limit the invention's particular form set forth, but on the contrary, it is intended to cover such alterations, modifications, and equivalences that may be included in the spirit and scope of the invention as defined by the appended claims.

1. A modular window for an aircraft, the modular window comprising:
a reveal;
a shade assembly having a shade, a fixed shade rail and a movable shade rail, the shade rails engaging the shade;
a frame for engaging the fixed shade rail;
an inner lens for engaging the frame;
an outer lens for engaging the reveal;
a drive system for engaging the frame and the movable shade rail for moving the shade between an open position and a closed position, the closed position for substantially preventing light from passing through the modular window, the drive system comprising a drive sprocket, a metal link chain, and an idler sprocket, the drive sprocket and idler sprocket engaging the metal link chain, the drive system including drive means for engaging and rotating the drive sprocket.

2. The modular window of claim 1, further including insulation, the insulation for location in a non-view obscuring area of the modular window.

3. The modular window of claim 1, wherein the shade is a pleated shade.

4. The modular window of claim 1, wherein the drive means comprises a handle adapted to be grasped manually and moved with respect to the frame.

5. The modular window of claim 1, wherein the drive means comprises an electric motor adapted to engage the frame, the drive sprocket, a remote electrical power source, and an electrical switch, the electric motor configured to rotate the drive sprocket responsive to manual input to the switch.

6. The modular window of claim 4, further including insulation, the insulation for location in a non-view obscuring area of the modular window.

7. The modular window of claim 5, further including insulation, the insulation for location in a non-view obscuring area of the modular window.

8. The modular window of claim 8, wherein the shade is a pleated shade.

9. The modular window of claim 7, wherein the shade is a pleated shade.

10. The modular window of claim 1, further including an alignment system, the alignment system for maintaining alignment of the moveable shade rail when it is moving.

11.

12. The modular window of claim 4, further including an alignment system, the alignment system for maintaining alignment of the moveable shade rail when it is moving.

13. The modular window of claim 5, further including an alignment system, the alignment system for maintaining alignment of the moveable shade rail when it is moving.

14. The modular window of claim 12, further including insulation, the insulation for location in a non-view obscuring area of the modular window.

15. The modular window of claim 13, further including insulation, the insulation for location in a non-view obscuring area of the modular window.

16. A modular window for an aircraft, the modular window comprising:
a reveal;
a shade assembly having a shade, a fixed shade rail and a movable shade rail, the shade rails engaging the shade;
a frame for engaging the fixed shade rail;
an inner lens for engaging the frame;
an outer lens for engaging the reveal;
a drive system for engaging the frame and the movable shade rail for moving the shade between an open position and a closed position, the closed position for substantially preventing light from passing through the modular window, the drive system comprising a drive sprocket, a metal link chain, and an idler sprocket, the drive sprocket and idler sprocket engaging the metal link chain, the drive system including drive means for engaging and rotating the drive sprocket;
further including insulation, the insulation for location in a non-view obscuring area of the modular window;
wherein the shade is a pleated shade;
wherein the drive means comprises a handle adapted to be grasped manually and moved with respect to the frame;
further including an alignment system, the alignment system for maintaining alignment of the moveable shade rail when it is moving; and
further including an alignment system, the alignment system for maintaining alignment of the moveable shade rail when it is moving.

17. A modular window for an aircraft, the modular window comprising:
a reveal;
a shade assembly having a shade, a fixed shade rail and a movable shade rail, the shade rails engaging the shade;
a frame for engaging the fixed shade rail;
an inner lens for engaging the frame;
an outer lens for engaging the reveal;
a drive system for engaging the frame and the movable shade rail for moving the shade between an open position and a closed position, the closed position for substantially preventing light from passing through the modular window, the drive system comprising a drive sprocket, a metal link chain, and an idler sprocket, the drive sprocket and idler sprocket engaging the metal link chain, the drive system including drive means for engaging and rotating the drive sprocket;
further including insulation, the insulation for location in a non-view obscuring area of the modular window;
wherein the shade is a pleated shade;
wherein the drive means comprises an electric motor adapted to engage the frame, the drive sprocket, a remote electrical power source, and an electrical switch, the electric motor configured to rotate the drive sprocket responsive to manual input to the switch; and
further including an alignment system, the alignment system for maintaining alignment of the moeable shade rail when it is moving.
